(19) United States
(12) Patent Application Publication
(10) Pub. No.: US 2006/0043814 A1
(43) Pub. Date: Mar. 2, 2006

(54) Trapezoidal field pole shape in salient machines

(76) Inventors: Raymond M. Calfo, Murrysville, PA (US); James A. Fulmer, North Huntingdon, PA (US)

Correspondence Address: Robert D. Kucler, Esq.;REED SMITH LLP, P.O. Box 488, Pittsburgh, PA, 15230-0488, US

(21) Appl. No.: 10/926,518

(22) Filed: Aug. 25, 2004

(51) Int. Cl. H02K 1/00; H02K 19/00

(52) U.S. Cl. 310/216; 310/162

(57) ABSTRACT

Salient pole motors and generators use a magnetic steel pole surrounded by an electrical winding to provide field excitation. The parallel sided shape of conventional field poles limit the amount of magnetic flux due to geometry and saturation constraints at the base of the pole. The base of the pole must carry the main flux plus the leakage flux. The optimum magnetic field pole shape is a trapezoidal configuration, that allows the flux density in the pole to be uniform. The base of the pole has a larger cross section to carry the main and leakage flux while the top of the pole is smaller to carry the main air gap flux.

### BACKGROUND OF THE INVENTION

1. Field of the Invention

The present invention relates generally to salient pole motors and generators, and more specifically, the present invention is directed to the use of trapezoidal-shaped magnetic field poles and partial air gap windings in synchronous machines to improve the uniformity of the flux density in these poles and to maximize magnetic shear stress.

2. Description of the Background

Synchronous electric motors having high power densities are an emerging technology in the motor industry. The required increases in power density are achieved by increasing the magnetic field strength of the rotor field, sometimes represented by the magnetic flux density in the rotor to stator air gap B, or by increasing the ampere loading of the stator winding, represented by the stator sheet current A. The power or torque density of the motor is proportional to the product of the current loading A and the air gap magnetic flux B. This product (A*B) is referred to as the magnetic shear stress of the motor.

However, the reactance of the motor is proportional to A divided by B multiplied by a permeance factor (A/B*P). The reactance of the motor is a parameter of significant importance to the electrical system that powers the motor and is usually required to exist within predefined “normal” bounds. Therefore, higher power density levels can not be achieved by improvements made solely to the stator sheet current loading A or to the air gap flux density B.

As such, continual improvements to the power density of motors subject to these constraints are continually sought. The present invention, in at least one preferred embodiment, addresses one or more of the above-described and other limitations of prior art solutions to this problem.

### SUMMARY OF THE INVENTION

In accordance with at least one preferred embodiment, the present invention provides devices and methods for increasing the power density of synchronous machines without significantly altering the reactance of the machine.

Specifically, the present invention includes two specific solutions to the power density problem. First, the shape of the conventional motor pole with parallel sides is tapered such that the base (rotor-side) of the motor pole is wider than the top (stator-side) of the motor pole. In effect, the motor pole becomes a trapezoid which advantageously alters the flux path running therethrough.

Additionally, a partial air gap winding may be employed utilizing a composite (non-metallic) stator tooth to effectively increase the air gap dimension of a stator cross-section. The increased air gap dimension, and associated reduction in electrical reactance, is useful for synchronous electric machines which require a significantly greater rotor field strength to maintain electrical reactances within normal values expected by conventional electric supply systems.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows a conventional field pole arrangement for a salient pole motor/generator;

FIG. 2 depicts an exemplary trapezoidal field pole design with field winding surrounding the pole;

FIG. 3 details a no-load flux plot for the exemplary trapezoidal field pole of FIG. 2;

FIG. 4 depicts a salient machine according to the present invention;

FIG. 5 is an exploded view of one portion of FIG. 4;

FIG. 6 shows a conventionally configured stator core and windings; and

FIG. 7 shows a partial air gap winding configuration according to the present invention.

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. Those of ordinary skill in the art will recognize that other elements are desirable and/or required in order to implement the present invention.

However, because such elements are well known in the art, and because they do not facilitate a better understanding of the present invention, a discussion of such elements is not provided herein. The detailed description will be provided hereinbelow with reference to the attached drawings.

According to principles well known in the motor arts, salient pole motors and generators use a magnetic steel pole surrounded by an electrical winding to provide field excitation. Conventional field poles utilize a parallel-sided shape that limits the amount of magnetic flux due to geometry and saturation constraints at the base of the pole. The base of the pole, therefore, must carry the main flux plus the leakage flux.

FIG. 1 generally shows this conventional field pole arrangement. The steel field pole utilizes a parallel-sided shape 110 for the main body 100 with a shaped pole head 120 near the air gap (above the pole head 120 in FIG. 1). Field windings 140 are then located around the parallel-sided edge 110 of the main body 100 of the motor pole. The pole head 120 typically extends beyond the edge of the pole body 100 (at 130) which mechanically constrains the field winding 140 during use of the salient machine.

The magnitude of flux that the field pole structure can carry is limited by the cross section of the parallel-sided pole. The total flux that the pole can carry is a combination of the flux that crosses the air gap plus the leakage flux. However, the leakage flux component does not contribute to the electromagnetic performance of the design.

High power density motors require a high magnetic shear stress. This shear stress is the product of the magnetic loading B and current loading A of the motor (A*B). The torque density of the motor can be maximized by maximizing this product (A*B). Because of its geometry, the conventional pole shown in FIG. 1 does not make efficient or optimum use of the available space.

For example, the flux density at the base or inner diameter of the pole (at 150) is much higher than at the rotor outer diameter. At the base 150, both the main flux and full leakage flux is present while at the outer diameter only the main flux exists. Since the pole is parallel sided (110) and thus a constant width, the flux density varies with radial location with the base 150 acting as the magnetic bottleneck. Conventional windings 140 are usually rectangular in cross section, and thus do not make full or optimum use of the space between adjacent rotor poles.

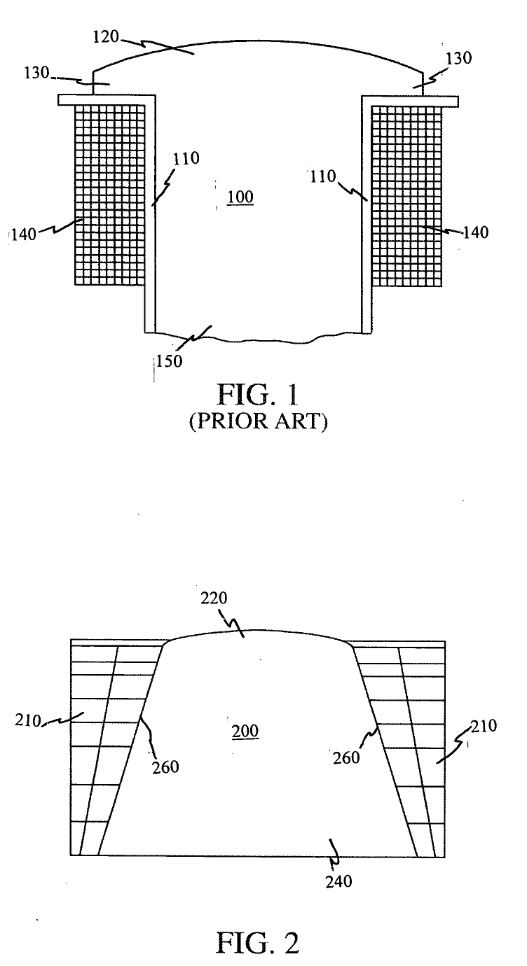

The pole arrangement shown in FIG. 2 is made according to the teachings of the present invention. This pole arrangement optimizes the use of the pole space and thus maximizes the magnetic shear stress (A*B) for a given motor volume, as described in more detail below. The optimum field pole geometry uses a trapezoidal shaped field pole. This geometry enables the flux density in the pole to be uniform throughout its radial depth or height and thus maximizes the magnitude of flux that crosses the air gap.

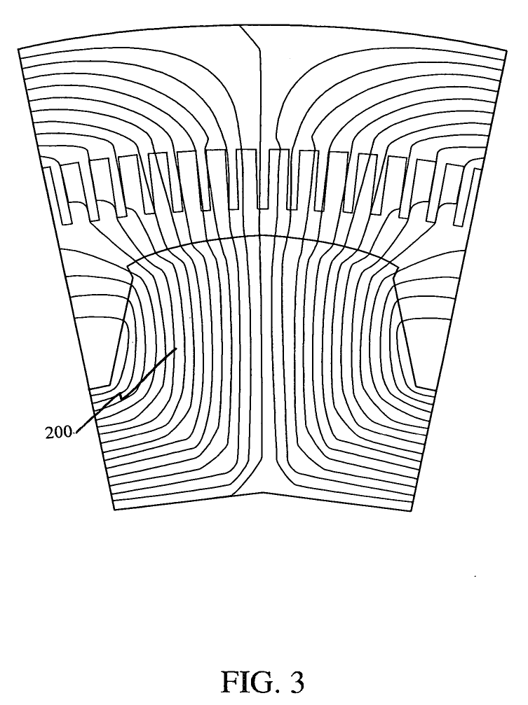

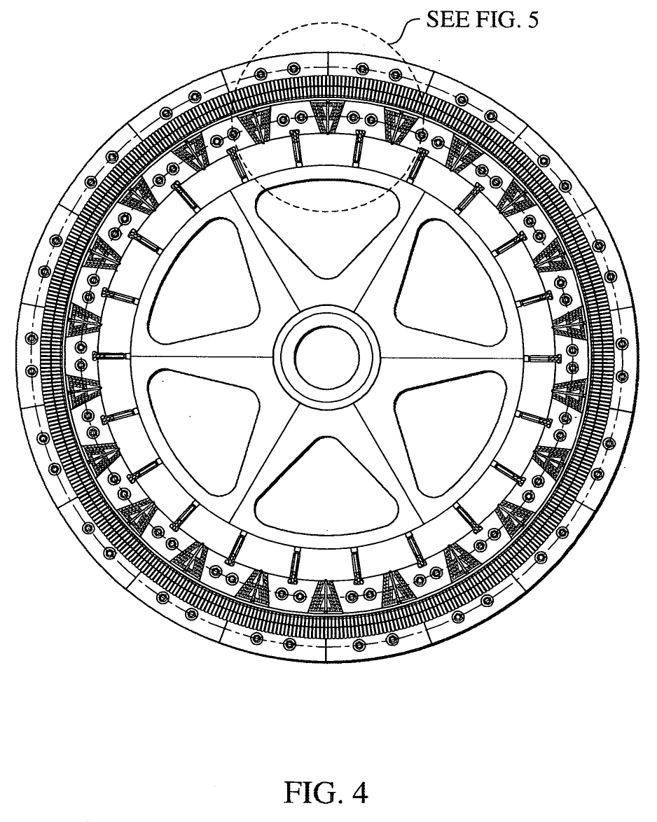

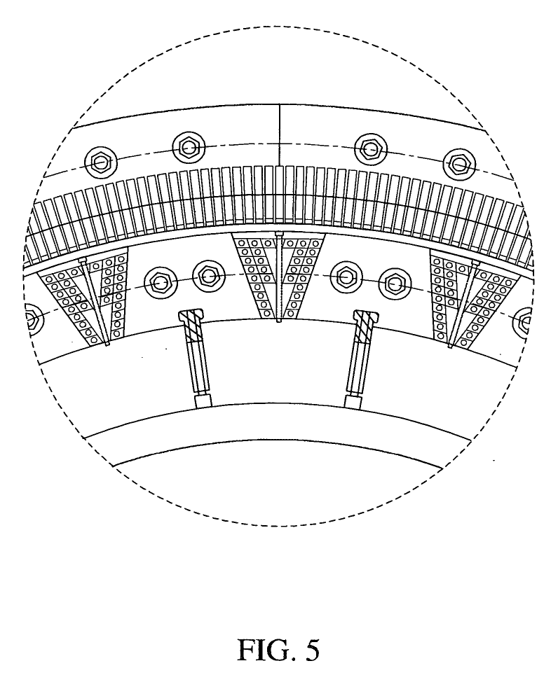

In more detail, FIG. 2 shows a trapezoidal field pole 200 design that has a field winding 210 surrounding the pole. Note in FIG. 2 that the field pole 200 has a smaller width at the air gap-side 220 (upper portion of FIG. 2 or stator-side) than at its base 240 (lower portion of FIG. 2 or rotor-side). The sides 260 of the field pole 200 are no longer parallel and instead taper towards each other at the air gap side 220. Likewise, the field windings 210 will follow the taper of the sides 260 of the trapezoidal field pole 200, and these field windings 210 will be nearer to each other at the air gap side of the pole 200. FIG. 3 shows a no-load flux plot for the exemplary trapezoidal field pole 200 that is depicted in FIG. 2.

It should be noted here that the use of the term “trapezoidal” in the present discussion is not limited to conventional notions of a trapezoid and instead is directed to the more general group of hexagonal-type shapes. The distinguishing feature of the “trapezoid,” as referenced herein, is that opposing sides of the pole are not parallel to each other.

The trapezoidal field pole design enables the generator or motor to utilize the higher flux density to operate at a higher electrical performance for the same physical space. This configuration allows greater rotor conductor cross sections and higher main air gap flux density B. The wider periphery gap between poles of the rotor outer diameter (air gap side 220) results in less leakage flux. This in turn allows a narrower pole base 240, more room for the field winding 210 and thus a higher current loading A, and a shallower rim depth.

The rim is the hub that magnetically connects the poles together. Thus, the trapezoidal shape of the motor pole 200 optimizes the allocation of both the pole magnetic material and pole conductor material.

Optional Partial Air Gap Winding

The trapezoidal rotor poles 200 described above may be put to particularly advantageous use when used in combination with a partial air gap winding. As described below, the partial air gap winding is useful in motors with higher shear stress and/or for lower reactance motors.

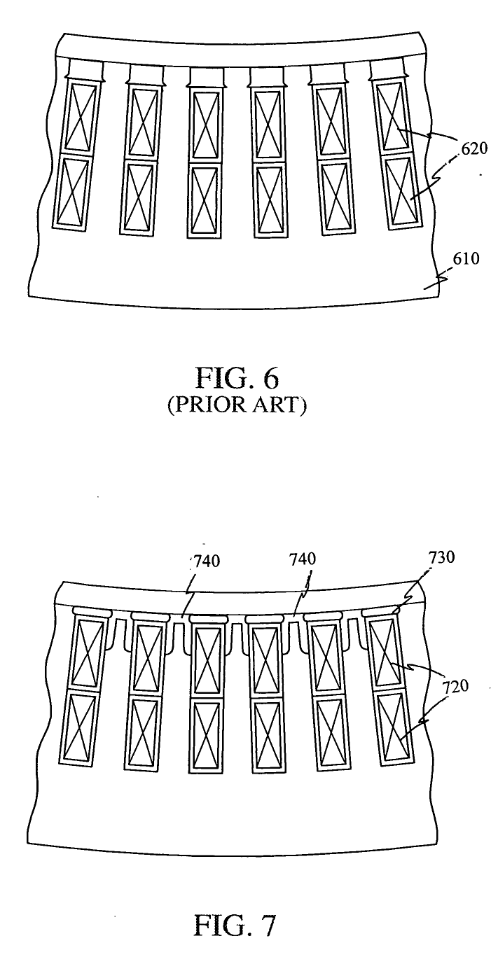

In general, the partial air gap winding utilizes a stator tooth extension of composite (non-metallic) material to effectively increase the air gap dimension of a stator cross-section (see FIG. 7). The increased air gap dimension, and associated reduction in electrical reactance, is useful for synchronous electric machines which require a significantly greater rotor field strength to maintain electrical reactances within normal values expected by conventional electric supply systems. The use of the composite tooth extension, in combination with a conventional stator wedge, achieves the reduced reactance winding with modest changes to the conventionally configured stator core. Conventional approaches to the reduced reactance would require much shallower stator slots, compromising the amount of copper and electrical current that can be carried in the slot, and ultimately limiting the power density of the overall machine.

In more detail, as described above, the power or torque density of the motor is proportional to the product of the current loading A and the air gap magnetic flux B—this product being referred to as the magnetic shear stress of the motor (A*B). However, the reactance of the motor is proportional to A divided by B multiplied by a permeance factor (A/B*P). The reactance of the motor is a parameter of significant importance to the electrical system that powers the motor and is usually required to exist within predefined “normal” bounds. Therefore, higher power density levels can not be achieved by improvements made solely to the stator sheet current loading A or to the air gap flux density B.

Also as described above, conventional stator designs for wound field synchronous motors and generators use parallel-sided slots with windings embedded in the slot and are held in place by a wedge. FIG. 6 shows a conventionally configured stator core and winding. The stator iron, comprising the stator teeth and the backiron, form the circuit through which the magnetic flux circulates. The stator coils or windings 620, which reside in the slots in the stator core iron 610, carry the electrical current. If the flux density B is increased to increase the magnetic shear stress, the stator tooth width must also be increased to prevent magnetic saturation. This reduces the allowable room for the stator coils 620 and thus results in a lower possible current loading A. This results in no net gain in the magnetic shear stress (A*B) according to the relationships defined above.

The inverse is also true. An increase in current loading for a given cooling scheme, and thus allowable current density in the coils 620, requires a wider and deeper coil. A wider coil results in a narrower stator tooth and thus a lower allowable flux density B. The proportions of the conventional stator teeth have an impact on the motors electrical reactance. A deep, narrow slot provides increased reactance, while a shallower, narrow slot reduces reactance.

The partial air gap winding of the present invention addresses the tradeoffs associated with the stator teeth and coil size by using composite stator tooth extensions attached to narrow stator teeth. FIG. 7 shows a partial air gap winding configuration according to the present invention. The windings 720 are held in place using a wedge 730 positioned between the composite tooth extensions 740. The narrow stator teeth are maintained for coil support. The design provides for increased current loading A which is compatible with increased magnetic loading B while maintaining a reasonable synchronous reactance. The machine reactances can be kept to a lower value with an air gap winding and thus allow more slot space available for current carrying capability. The reactance may be controlled by varying the length of the composite tooth extensions 740.

The partial air gap winding is particularly complimentary to advanced rotor technologies that provide for dramatically increased magnetic field capability compared to conventional designs. Rotors with high temperature super-conducting conductors can generate magnetic fields far greater than typical salient pole designs. Likewise, salient rotor pole technology can be modified with advanced conductor cooling, magnetic materials and optimized pole shapes (such as the trapezoidal shape described above) to provide improved magnetic field strength. In both cases, the higher flux densities B require a lower reactance stator to maintain balanced system performance.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention.

Accordingly, it is understood that the drawings and the descriptions herein are proffered only to facilitate comprehension of the invention and should not be construed to limit the scope thereof.

1. A synchronous machine with improved power density, comprising:
a rotor including a plurality of field poles, each pole having a rotor-side and a stator-side; and
a stator adjacent to said rotor, wherein the rotor-side of each of said poles is wider than the stator-side of said poles.

2. The machine of claim 1, wherein each of said poles has two opposing side surfaces which are not parallel to each other.

3. The machine of claim 1, wherein each of said poles is trapezoidal.

4. The machine of claim 1, further comprising:
field windings around each of said poles.

5. The machine of claim 4, wherein the stator-side of each of said poles is extended to mechanically restrain said field windings.

6. The machine of claim 5, wherein said field windings are tapered.

7. The machine of claim 1, wherein flux density passing through said poles is uniform throughout a radial depth of the pole.

8. The machine of claim 1, wherein said stator further includes at least one stator tooth extension.

9. The machine of claim 8, wherein said stator tooth extension is made of a composite material.

10. A salient pole machine with improved power density, comprising:
a stator adjacent; and
a rotor adjacent to said stator including a plurality of field poles, each pole having two opposing side surfaces that run generally radially between the rotor and the stator, wherein said two opposing side surfaces are not parallel to each other.

11. The machine of claim 10, wherein each of said poles has a rotor-side surface and a stator side surface, wherein said rotor-side surface is widers than said stator-side surface.

12. The machine of claim 10, wherein each of said poles is trapezoidal.

13. The machine of claim 10, further comprising:
field windings around each of said poles.

14. The machine of claim 13, wherein the stator-side of each of said poles is extended to mechanically restrain said field windings.

15. The machine of claim 14, wherein said field windings are tapered.

16. The machine of claim 10, wherein flux density passing through said poles is uniform throughout a radial depth of the pole.

17. The machine of claim 10, wherein said stator further includes at least one stator tooth extension.

18. The machine of claim 17, wherein said stator tooth extension is made of a composite material.

19. A synchronous machine with improved power density, comprising:
a rotor including a plurality of field poles, each pole having a rotor-side and a stator-side;
a stator adjacent to said rotor, wherein the rotor-side of each of said poles is wider than the stator-side of said poles; and
at least one stator tooth extension attached to windings in said stators to effectively decrease an air gap created between said rotor and said stator.

20. The machine of claim 19, wherein said stator tooth extension is made of a composite material.
